(19) United States
(12) Patent Application Publication
(10) Pub. No.: US 2007/0287063 A1
(43) Pub. Date: Dec. 13, 2007

(54) Battery Pack

(76) Inventors: Masaru Hiratsuka, Kanagawa (JP); Mitsuo Sakamoto, Tokyo (JP); Kazuhito Hatta, Fukushima (JP); Kenji Tsuchiya, Fukushima (JP); Ken Segawa, Fukushima (JP); Masato Sato, Fukushima (JP); Akira Ichihashi, Fukushima (JP); Kazuo Honda, Fukushima (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/572,435

(22) PCT Filed: Jul. 22, 2005
(86) PCT No.: PCT/JP05/13901

§ 371 Date: Jan. 22, 2007

(30) Foreign Application Priority Data
Jul. 23, 2004 (JP) 2004-215097
Jul. 1, 2005 (JP) 2005-194096

(51) Int. Cl. H01M 2/10; B21D 51/52

(52) U.S. Cl. 429/177; 29/623.2

(57) ABSTRACT

By using a DI molding method or a roll forming method, a casing member made of a thin cylindrical metal pipe is formed and molded so as to almost coincide with a shape of a battery element, thereby forming an outer casing. A power generating element to which a circuit board has been connected is enclosed in the outer casing and opening portions of the outer casing are closed by a front cap and a rear cap formed by, for example, a resin molding, thereby forming a battery pack. The power generating element is used by externally covering the battery element with a laminate film or the battery element is enclosed as it is into the outer casing. To suppress the penetration of the moisture into the battery, it is also possible to mix a moisture trapper for absorbing the moisture into a resin material of the front cap and rear cap and suppress the penetration of the moisture.

### TECHNICAL FIELD

The invention relates to a battery pack which is suitable when it is applied to, for example, a rectangular polymer battery.

### BACKGROUND ART

In recent years, portable electronic apparatuses such as notebook-sized personal computer, cellular phone, PDA (Personal Digital Assistants), and the like have been spread, and lithium ion batteries having advantages such as high voltage, high energy density, and light weight are widely used as power sources.

Further, as a countermeasure for a liquid leakage which becomes a problem in the case of using a liquid system electrolytic solution, for example, a lithium ion polymer secondary battery in which a gel high polymer film obtained by impregnating a non-aqueous electrolytic solution into polymer or a total solid electrolyte is used as an electrolyte has been put into practical use.

The lithium ion polymer secondary battery has a construction of a battery cell in that a battery element which has a positive electrode, a negative electrode, a polymer electrolyte and in which leads are respectively led out from the positive electrode and the negative electrode is covered with an outer film, for example, an aluminum laminate. Further, the battery cell is enclosed into a box-shaped molded casing formed by a pair of upper and lower casings made of a resin together with a wiring board having a protecting circuit, connecting terminals, and the like.

As mentioned above, the conventional polymer battery in which the battery element covered with the aluminum laminate, the wiring board, and the like are covered with the molded casing formed by the pair of upper and lower casings is finally sold as a product to the user or the like as a battery pack.

In such a battery pack, it is demanded to improve volume energy efficiency. For example, in JP-A-2002-184364, there has been proposed a rectangular battery of a structure in which four mutually connected surfaces of a battery cell are continuously covered with one resin film and a joint portion in which the resin film covering the battery cell is overlaid is positioned into one surface of a small area of the battery cell, thereby reducing a thickness.

However, the conventional battery pack has the following problems. According to the structure of the conventional battery pack in which the battery cell is covered with the molded casing, in order to protect the battery cell against a shock or the like which is applied from the outside, it is necessary to set the thickness of molded casing to a value within a range from about 0.3 to 0.4 mm. Therefore, when considering a double-sided adhesive tape for fixing the battery cell to the molded casing, a tolerance upon molding of the molded casing, or the like, a thickness of battery pack is increased more than that of the battery cell by about 0.8 to 1.0 mm.

According to the structure in which the battery cell is covered with the molded casing formed by the pair of upper and lower casings made of the resin, in the case of preferably joining the upper and lower casings by, for example, ultrasonic welding, it is necessary to set a thickness of joint portion to about 0.7 mm. Consequently, the thickness of battery pack is increased more than that of the battery cell by about 1.4 mm. In the case of the battery cell having a thickness of about 4.0 mm, it is inevitable to increase a volume of battery pack by an amount of about 1.3 to 1.4 times as large as that of the battery cell.

Further, according to the battery pack of the current polymer battery, the battery element is wrapped by a laminate film having a thickness of about 0.1 mm, the laminate film in a peripheral portion of the battery element is sealed by thermal welding or the like, and a resultant battery assembly is further enclosed into a casing made of plastics. There is, consequently, a problem that if such a battery pack is enclosed into a metal can similar to that of the liquid system battery, volume efficiency deteriorates.

To avoid such a problem, by covering the battery cell with a casing made of a metal, even if the thickness is small, the battery pack having sufficient hardness can be constructed. For example, an aluminum can is used as an outer casing of a rectangular battery pack of a lithium ion battery or the like using a liquid system electrolyte. A rectangular metal can which is formed by aluminum or the like is mainly molded by a drawing process.

However, when thinning the metal can which is molded by the drawing process, a limit thickness of such a metal can is equal to about 0.2 mm in the present situation. This is because a height of opening of the metal can which is molded by the drawing process depends on a strength of a die (die set) for drawing. It is, therefore, difficult to realize a thickness which is equal to or less than about 0.1 mm only by using the ordinary drawing process.

It is, therefore, an object of the invention to provide a battery pack in which by reducing a thickness of outer casing covering a battery cell, an increase in volume due to the outer casing is decreased and a mechanical strength and reliability and safety of terminals can be assured.

### DISCLOSURE OF INVENTION

To accomplish the above object, according to the invention, a rectangular battery cell is inserted into an outer casing made of a metal obtained by molding a cylinder whose thickness of peripheral surface is small into a cylindrical shape that almost coincides with an outer shape of the rectangular battery cell and caps are respectively fitted to opening portions of both ends of the outer casing, thereby forming a battery pack. At this time, the rectangular battery cell can be formed by externally covering a battery element with a laminate film or the battery element maybe used as it is. To suppress penetration of the moisture into the battery element portion, the caps can be also formed by mixing a moisture trapper for absorbing the moisture into a resin forming the caps fitted to the opening portions of the both ends of the outer casing.

### BRIEF DESCRIPTION OF DRAWINGS

FIG. 1 is a schematic diagram showing a structure of a battery pack to which the invention is applied.

FIG. 2 is a schematic diagram showing a structure of a battery element which is enclosed in the battery pack.

FIG. 3 is a schematic diagram showing an external view of the battery pack to which the invention is applied.

FIG. 4 is a schematic diagram showing steps of a DI (Drawing with ironing) molding method as a manufacturing method of an outer casing to which the invention is applied.

FIG. 5 is a schematic diagram showing steps of the DI molding method.

FIG. 6 is a schematic diagram specifically showing the DI molding method.

FIG. 7 is a schematic diagram showing a manufacturing method of the outer casing, to which the invention is applied.

FIG. 8 is a schematic diagram showing a manufacturing method of the outer casing to which the invention is applied.

FIG. 9 is a schematic diagram showing another example of a fitting method of a cap.

FIG. 10 is a schematic diagram showing another example of the fitting method of the cap.

FIG. 11 is a schematic diagram showing an example of another structure of the cap, in which A is a side elevational view, B is a cross sectional view taken along the X1-X1 line in A, C is a plan view, D is a cross sectional view taken along the Y1-Y1 line in C, and E is a side elevational view when seen from the side opposite to A.

FIG. 12 is a schematic diagram showing another example of the fitting method of the cap.

FIG. 13 is a schematic diagram showing a structure of the battery pack to which the invention is applied.

FIG. 14 is a schematic diagram showing steps in the case where the outer casing to which the invention is applied is formed by a roll forming method.

### BEST MODE FOR CARRYING OUT THE INVENTION

An embodiment of the invention will be described hereinbelow with reference to the drawings. As mentioned above, in the invention, as a battery cell which is enclosed in an outer casing, a battery cell formed by externally covering a battery element with a laminate film can be used or the battery cell maybe used as it is. First, the battery cell formed by externally covering the battery element with the laminate film will be described in detail.

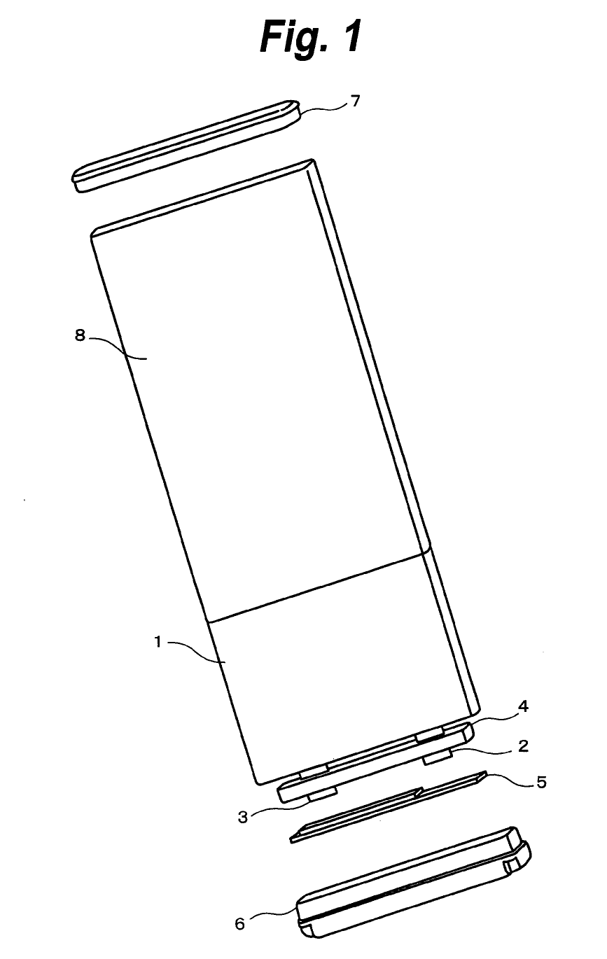

FIG. 1 is an exploded perspective view of a battery pack according to an embodiment. Reference numeral 1 denotes a battery cell of a battery such as a lithium ion polymer secondary battery. The battery cell 1 is formed by covering a battery element with a laminate film serving as a sheathing member. An outer shape of the battery cell 1 is almost rectangular.

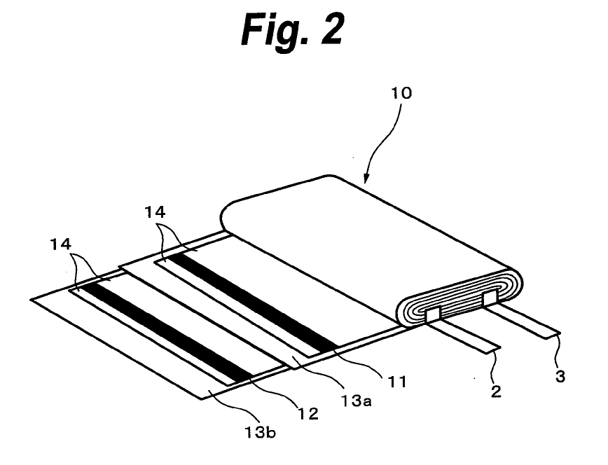

As shown in FIG. 2, a battery element 10 is constructed in such a manner that a belt-shaped positive electrode 11 is laminated onto a separator 13a, a belt-shaped negative electrode 12 is laminated onto a separator 13b, they are wound in the longitudinal direction, a lead 2 is led out of the positive electrode 11, and a lead 3 is led out of the negative electrode 12, respectively. A laminate electrode assembly obtained by laminating the positive electrode and the negative electrode together with the separators may have a structure in which they are laminated by a bending method, a piling method, or the like besides the structure in which they are wound in the longitudinal direction.

In the positive electrode 11, a positive electrode active material layer is formed on a belt-shaped positive electrode collector and, further, a polymer electrolytic layer 14 is formed on the positive electrode active material layer. In the negative electrode 12, a negative electrode active material layer is formed on a belt-shaped negative electrode collector and, further, the polymer electrolytic layer 14 is formed on the negative electrode active material layer. The leads 2 and 3 are joined to the positive electrode collector and the negative electrode collector, respectively. The following materials, which have already been proposed, can be used as a positive electrode active material, a negative electrode active material, and a polymer electrolytic.

In the positive electrode, a metal oxide, a metal sulfide, or a specific high polymer can be constructed as a positive electrode active material in accordance with a kind of target battery. For example, in the case of forming the lithium ion battery, a lithium complex oxide or the like mainly containing LiₓMO₂ (in the expression, M denotes one or more kinds of transition metals and x is a value which is ordinarily equal to or larger than 0.05 and equal to or smaller than 1.10 although it differs depending on a charging/discharging state of the battery) can be used as a positive electrode active material. Cobalt (Co), nickel (Ni), Manganese (Mn), and the like are preferable as transition metals M constructing the lithium complex oxide.

As specific examples of such a lithium ion complex oxide, LiCoO₂, LiNiO₂, LiMn₂O₄, LiNi_{y}CO_{1-y}O₂ (0<y<1), and the like can be mentioned. According to those lithium complex oxides, a high voltage can be generated and an excellent energy density can be obtained. A metal sulfide or oxide such as TiS₂, MOS₂, NbSe₂, V₂O₅, or the like which does not contain lithium can be also used as a positive electrode active material. A combination of a plurality of kinds of those positive electrode active materials can be also used as a positive electrode. When the positive electrode is formed by using the positive electrode active materials as mentioned above, a conductive material, a binder, or the like may be added.

For example, a carbon material such as carbon black or graphite or the like is used as a conductive material. For example, polyvinylidene fluoride, polytetrafluoroethylene, polyvinylidene fluoride, or the like is used as a binder.

A material which can dope or dedope lithium can be used as a negative electrode material. For example, a carbon material such as graphitization-resistant carbon material or graphite material can be used. More specifically speaking, it is possible to use a carbon material such as pyrolytic carbon class, coke class (pitch coke, needle coke, petroleum coke), graphite class, vitrified carbon class, organic high polymer compound baked material (obtained by baking a phenol resin, a fran resin, or the like at a proper temperature and carbonizing it), carbon fiber, activated charcoal, or the like. Further, a high polymer such as polyacetylene, polypyrrole, or the like or an oxide such as SnO₂ or the like can be used as a material which can cope or dedope lithium. When the negative electrode is formed from those materials, the binder or the like may be added. For example, polyvinylidene fluoride, styrene-butadiene rubber, or the like is used as a binder.

The polymer electrolyte is formed by a method whereby an electrolyte in which a high polymer material, an electrolytic solution, and electrolytic salt are mixed so as to become a gel is penetrated into a polymer. The high polymer material has a nature in which it is compatible with the electrolytic solution and the following materials are used: silicon gel; acrylic gel; acrylonitrile gel; polyphosphazene-denatured polymer; polyethylene oxide; polypropylene oxide; and their complex polymer, bridging polymer, denatured polymer, and the like; or as fluorocarbon polymer, for example, a high polymer material such as poly(vinylidene fluoride), poly(vinylidene fluoride-co-hexafluoropropylene), poly(vinylidene fluoride-co-trifluoropropylene), or the like; and their mixture.

The electrolytic solution component can disperse the foregoing high polymer material and, as a non-protic solvent, for example, ethylene carbonate (EC), propylene carbonate (PC), butylene carbonate (BC), or the like is used. As an electrolytic salt, a material which is compatible with the solvent is used and is constructed by a combination of a cation and an anion. An alkali metal or an alkaline earth metal is used as a cation. Cl⁻, Br⁻, I⁻, SCN⁻, ClO₄⁻, BF₄⁻, PF₆⁻, CF₃SO₃⁻, or the like is used as an anion. Specifically speaking, the electrolytic salt of such a concentration that lithium phosphate hexafluoride (LiPF₆) or lithium borate tetrafluoride (LiBF₄) can be dissolved to the electrolytic solution is used.

The laminate film is a multilayer film obtained by adhering a film-shaped metal and a synthetic resin and has such a structure that, for example, a thermally welding layer, a metal layer, and a surface protecting layer are laminated in order from the inside which is come into contact with the battery element. A polypropylene (PP) layer or a polyethylene (PE) layer can be used as a thermally welding layer. An aluminum (Al) layer can be used as a metal layer. A nylon layer or a polyethylene terephthalate (PET) layer can be used as a surface protecting layer.

The polypropylene layer and the polyethylene layer have a function of thermally welding and a function of preventing alteration of the polymer electrolyte. Casted polypropylene (CPP) (non-oriented polypropylene) or the like is used as a polypropylene layer. Non-oriented low-density polyethylene (LLDPE) or the like is used as an ethylene layer. For example, a polypropylene (PP) layer having a thickness of about 30 μm is formed. The polypropylene (PP) layer and the polyethylene layer have a melting point of such an extent that the battery cell 1 is not influenced by the heat which is applied to the battery cell 1 upon thermal welding.

The aluminum layer has a function of preventing the moisture from penetrating into the layer. Annealing-processed aluminum (8021-O JIS H 4160) or (8079-O JIS H 4160) or the like can be used as an aluminum layer. The aluminum layer whose thickness lies within a range from about 30 to 130 μm is used. In the case where the resin or adhesive agent constructing the laminate film has a function of absorbing the moisture or an evaporation deposition film serving as a barrier for blocking the moisture penetration, such a metal layer can be omitted.

The nylon layer or the polyethylene terephthalate (PET) layer has a function of insulating the aluminum layer from the outside of the battery cell 1 and has a thickness of about 10 to 30 μm. By forming the polypropylene layer to the inside of the aluminum layer which is come into contact with the battery element and by forming the nylon layer or the polyethylene terephthalate (PET) layer to the outside, the polypropylene layer is welded prior to the nylon layer or the polyethylene terephthalate (PET) layer. Therefore, for example, in the case of sealing the laminate material by the thermal welding, they can be easily joined.

The leads 2 and 3 respectively connected to the positive electrode and the negative electrode are led out of one (front side) of the edge surfaces of the battery cell 1. A holding member 4 is attached to the leads 2 and 3, for example, so as to sandwich the leads 2 and 3 together. The holding member 4 is made of, for example, a synthetic resin material having insulation performance, stably holds a circuit board 5, and insulates the circuit board 5 from the battery cell 1.

The circuit board 5 is fixed to the leads 2 and 3 projected from the holding member 4 by resistance welding, ultrasonic welding, or the like. The circuit board 5 has a role for connecting the outside of the battery pack to the battery cell 1. A protecting circuit including temperature protecting elements such as fuse, PTC (Positive Temperature Coefficient: thermally-sensitive resistive element), a thermistor, and the like, an ID (identification) resistor for identifying the battery pack, and the like are mounted on the circuit board 5. The PTC is serially connected to the battery element. When a temperature of the battery is higher than a set temperature, an electric resistance rises suddenly, thereby substantially shutting off a current flowing in the battery. The fuse and the thermistor are also serially connected to the battery element. When the temperature of the battery is higher than the set temperature, they shut off the current flowing in the battery.

The circuit board 5 fixed to the leads 2 and 3 are enclosed in a front cap 6. A plurality of, for example, three contact portions are formed on the circuit board 5 of the front cap 6 side.

The front cap 6 and a rear cap 7 are molded members which are molded from, for example, a synthetic resin material such as polycarbonate (PC), polypropylene (PP), ABS resin (acrylonitrilebutadiene styrene), hot melt resin of a polyamide system, or the like, or from the same material as that of an outer casing 8, which will be explained hereinafter, for example, a metal material such as aluminum, stainless steel (SUS), or the like. The front cap 6 and the rear cap 7 are attached to opening portions at both ends of the cylindrical outer casing 8, respectively, and close the outer casing 8.

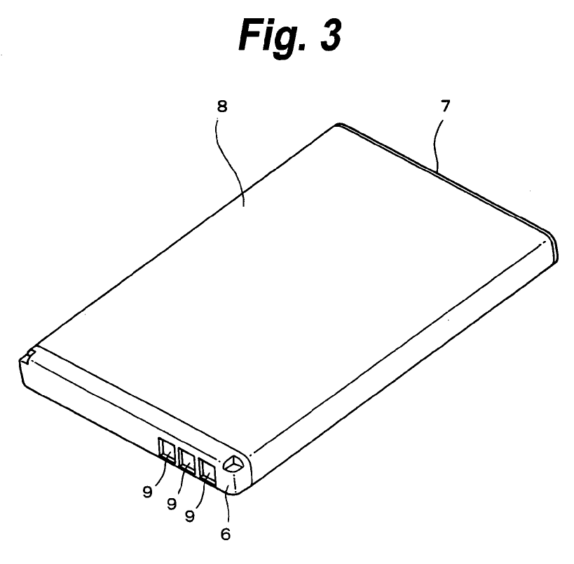

A holding portion to hold the enclosed circuit board 5 so as not to be swing is provided for the inside of the front cap 6. As shown in FIG. 3, openings 9 are formed in positions of the front cap 6 corresponding to the contact portions which the circuit board 5 has. The contact portions of the circuit board 5 are exposed to the outside through the openings 9. The openings 9 are provided to electrically connect the contact portions formed on the circuit board 5 fixed to the inside of the front cap 6 and an external circuit. Since the front cap 6 has the openings 9, it is preferably made of the synthetic resin material.

A pair of caps comprising the front cap 6 and the rear cap 7 are joined to the outer casing 8 by an attaching method suitable for the material of them. If the caps are made of the synthetic resin material, for example, by laminating a thin film of polypropylene (PP), polyethylene (PE), or the like onto the joint surfaces of the outer casing 8 and the caps and heating the joint surfaces, the caps and the outer casing 8 can be fixed by thermal welding.

The front cap 6, rear cap 7, and outer casing 8 may be adhered with a resin system adhesive agent such as a chemical reaction type adhesive agent containing silicone deformed polymer as a main component, for example, “Super X series” made by Cemedine Co., Ltd., or the like. If a hot melt system resin is used, the outer casing 8 and the caps can be adhered simultaneously with the molding of the outer shapes of the front cap 6 and the rear cap 7. The outer casing 8, front cap 6, and rear cap 7 can be also joined by caulking.

If the front cap 6 and the rear cap 7 are made of the same material as that of the outer casing 8, for example, the metal material such as aluminum or the like, they can be joined by the welding or the like performed upon creation of a rectangular can made of aluminum used in the conventional lithium ion polymer battery.

The outer casing 8 has a cylindrical shape adapted to insert and enclose the battery cell 1 therein. The outer casing 8 is formed by a molding method, which will be explained hereinafter, so that its thickness is very small to be about 0.1 mm. The outer casing 8 is made of a material which can protect the internal battery cell 1 against a shock or the like from the outside even if its thickness is small, for example, a metal such as aluminum, iron, stainless steel (SUS), or the like. A material such as 3003H18, 3004H18, 1N30H18, or the like can be used as aluminum. According to those aluminum materials, since a Vickers hardness is equal to or larger than 20, even if the thickness of outer casing is very small to be equal to about 0.1 mm, the strength can be assured.

The battery pack having an external view shown in FIG. 3 is constructed by the component elements as mentioned above.

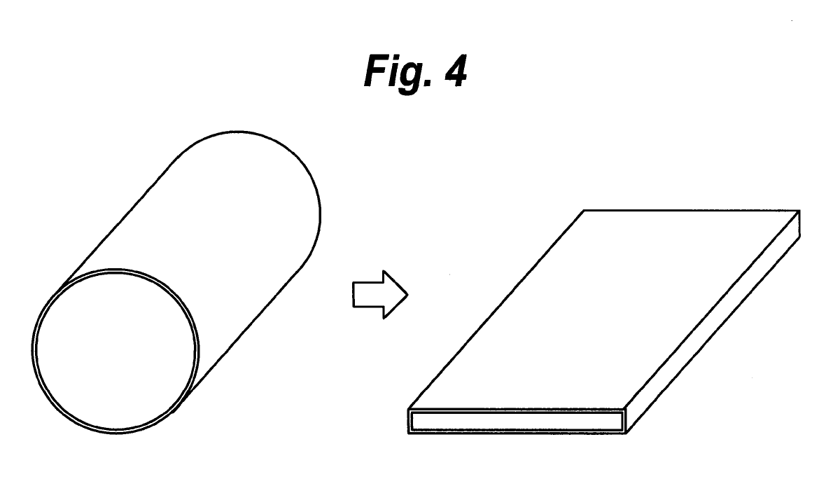

The molding method of the outer casing 8 will now be described. Fundamentally, the strength of outer casing having the cylindrical shape at the time of thinly forming the side wall is stronger and the side wall can be formed thinner as compared with the outer casing having the rectangular pipe shape. For example, a limit value of the thickness of side wall of the rectangular pipe shape is equal to about 0.2 mm when the outer casing is thinned. However, the thickness of side wall of the cylindrical shape can be reduced to about 0.1 mm. By using such a fact, as shown in FIG. 4, the outer casing 8 is first formed into the cylindrical shape and worked so that a thickness of peripheral surface of the cylinder is reduced to about 0.1 mm. Subsequently, it is molded into a pipe shape which almost conforms with the outer shape of the battery cell 1, that is, into a rectangular pipe shape. A cylindrical casing member whose side wall is thin is molded by, for example, a DI (Drawing with ironing) molding method. The DI molding method is a kind of press working techniques and the side wall can be thinly formed by drawing and ironing.

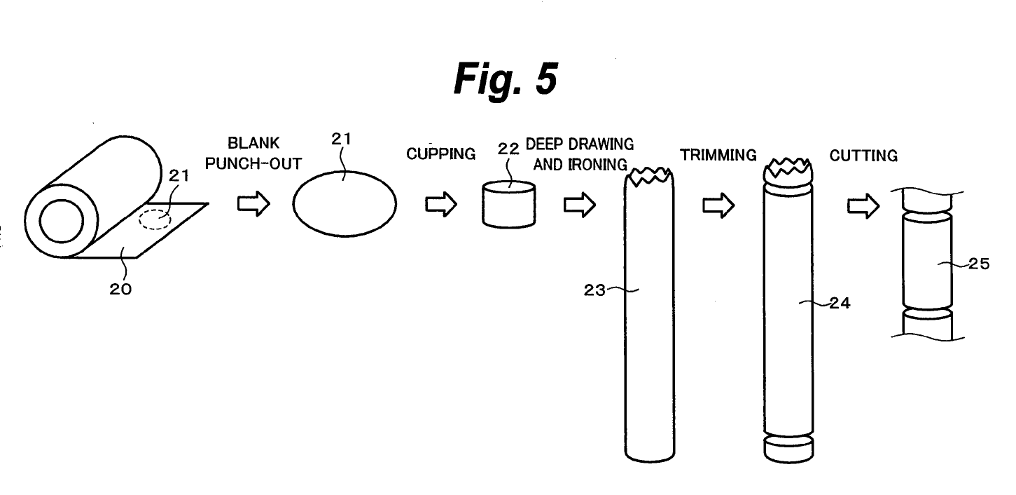

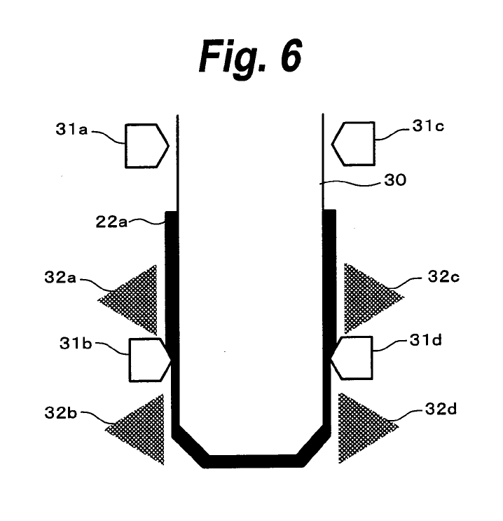

An example of the creation of the casing member (outer casing) by the DI molding method will be described with reference to FIGS. 5 and 6. First, in a blank punching-out step, a disk 21 called a blank is punched out from a metal plate 20 having a thickness of about 0.3 mm. In a cupping step, an outer peripheral side of the punched blank 21 is held and a center portion of the blank 21 is pressed, thereby molding a cup-shaped casing member 22 with the low side wall.

In a deep drawing and ironing step, the circular can, that is, the cup-shaped casing member 22 is miniaturized by the deep drawing so that a diameter of the cylindrical portion is equal to a desired size and the side wall of the cylindrical portion is thinly extended by the ironing molding. Thus, a casing member 23 in which a thickness of peripheral surface is very small to be equal to about 0.1 mm can be obtained. A bore of a cylindrical portion of the casing member 23 is set so that the battery cell 1 can be inserted and its inner area is slightly larger than an area of an inserting surface of the battery cell 1.

In a trimming step, both ends of the casing member 23 to which the deep drawing and the ironing have been executed are trimmed. Thus, a cylindrical casing member 24 having a peripheral surface of desired thickness and bore is formed. The reason why a concave/convex portion of the side wall edge of the casing member 23 formed by the deep drawing and ironing is cut and separated and a bottom portion is also cut and separated by trimming is to obtain the rectangular pipe shape instead of the circular can.

In a cutting step, the side wall of the casing member 24 is cut so that its height is equal to a length corresponding to a length of battery cell 1 which is enclosed, thereby forming a cylindrical casing member 25 according to the shape of battery cell 1. Thus, the cylindrical casing member as shown in FIG. 4 is formed. For example, a plurality of cylindrical casing members 15 according to the shape of battery cell 1 can be obtained from one cylinder obtained in the trimming step.

The deep drawing and ironing method will now be described in detail with reference to FIG. 6. The cup-shaped casing member 22 is deeply drawn by using a punch 30 and ironed by ironing dies 31a, 31b, 31c, and 31d. Casing member 22a during the step of forming the thin casing member 23 from the cup-shaped casing member 22 is shown in FIG. 6. At this time, moldability of the casing member 22a can be improved by lubricants/coolants shown at reference numerals 32a, 32b, 32c, and 32d.

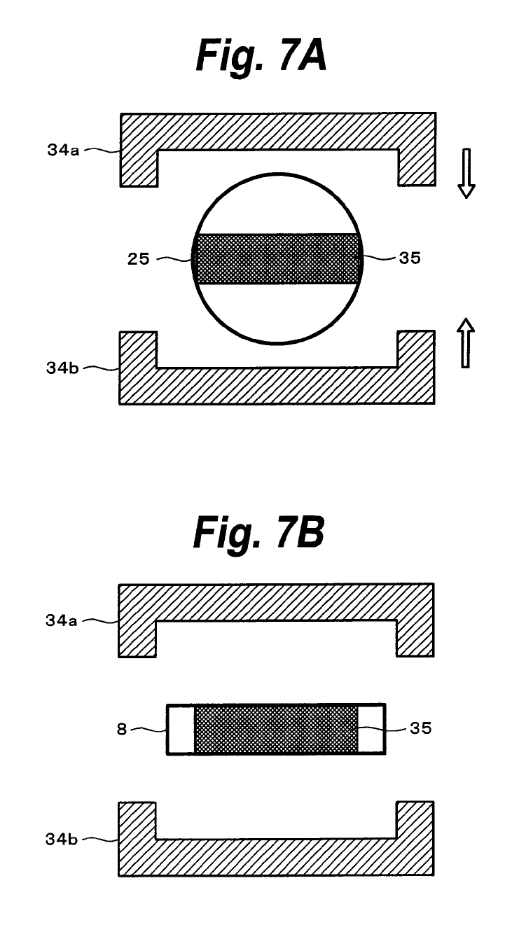

After the cylindrical casing member 25 having a large thickness was formed in this manner, the formed casing member 25 is molded into a rectangular pipe shape which almost conforms with the outer shape of the battery cell 1. The rectangular pipe shape can be molded by, for example, using dies 34a and 34b and a molding member 35 to the cylindrical casing member 25 as shown in FIGS. 7A and 7B. Thus, the outer casing 8 of the rectangular pipe shape adapted to insert the battery cell 1 can be formed as shown in FIG. 7B.

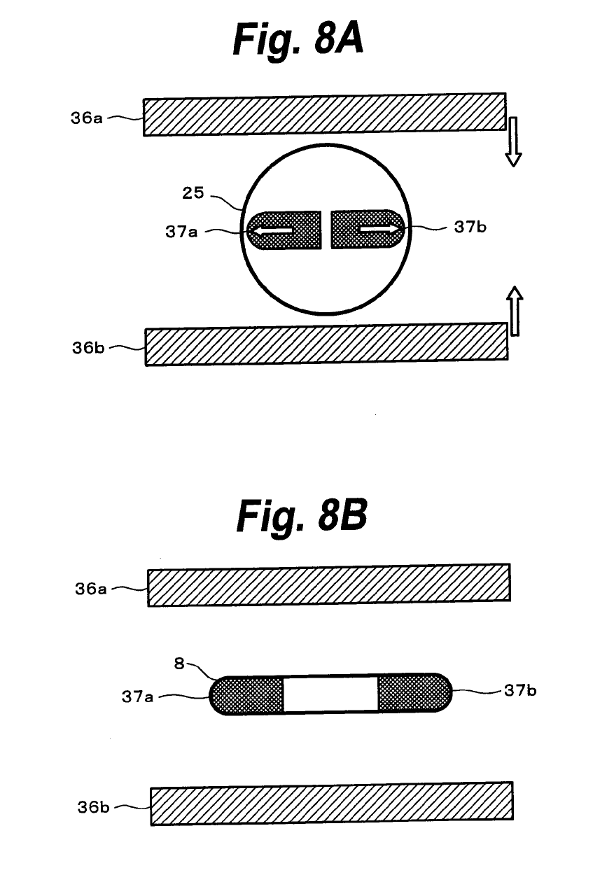

A method shown in FIGS. 8A and 8B can be also used. In this case, an outer casing whose cross section has almost an elliptical shape can be obtained by using dies 36a and 36b and molding members 37a and 37b to the cylindrical casing member 25.

The molding method of the rectangular pipe shape is not particularly limited so long as it can mold the rectangular pipe shape from the cylindrical shape.

In the creation of the conventional rectangular pipe shape, it is difficult to set the thickness of peripheral surface to about 0.2 mm or less in terms of the strength. However, after the thickness of peripheral surface of the cylinder was reduced owing to the cylindrical shape, the casing member is molded into the rectangular pipe shape according to the shape of the battery cell 1, so that the rectangular pipe shape in which the thickness of peripheral surface is very small to be equal to about 0.1 mm can be formed. The seamless strong outer casing 8 of the rectangular pipe shape in which the thickness of peripheral surface is very small as mentioned above is formed.

The battery cell 1 to which the circuit board 5 has been joined is inserted into the outer casing 8 of the rectangular pipe shape and both ends of the outer casing 8 are closed by the front cap 6 and the rear cap 7, respectively, so that the battery pack is formed. The circuit board 5 can be also joined to the battery cell 1 after the battery cell 1 was inserted into the outer casing 1. The battery cell 1 has characteristics in which it is expanded by the initial charging and, thereafter, is not returned to the original size irrespective of the charging/discharging state. Therefore, for example, by charging the battery element after the battery cell 1 before the initial charging was inserted into the outer casing 8, the battery cell 1 is closely adhered into the outer casing 8 by the expansion of the battery cell 1, thereby enabling the battery cell 1 to be fixed.

Processes for insulation and an external appearance of the outer casing 8 and the like are executed as necessary by a method similar to that in the case of the battery pack of the conventional lithium ion polymer secondary battery. In the case of executing the insulating process by forming a resin layer or the like onto the outer surface of the outer casing 8, information such as characters, picture, or the like can be also printed onto the resin layer by a laser. Thus, a design or product information can be printed without using a label and it is possible to further contribute to the improvement of the volume efficiency.

As described above, in the battery pack according to the embodiment, when the outer casing 8 is formed, it is formed into the cylindrical shape of the thin side wall by the DI molding method or the like and, thereafter, the outer casing is molded into the rectangular pipe shape suitable for insertion of the battery cell 1. Therefore, even if the outer casing 8 has the rectangular pipe shape, the outer casing in which the thickness of side wall is very small can be seamlessly formed. Thus, even if the battery cell 1 is rectangular, the outer casing 8 whose thickness is very small and which has a high strength can be used. Consequently, an increase in capacity necessary for the outer casing 8 can be decreased and the sufficient mechanical strength and the reliability and safety of the terminals can be assured. In the case of the conventional battery pack using the molded casing, although the volume efficiency to the battery main body is equal to about 78%, in the case of the battery pack according to the invention, the volume efficiency of 90% or more can be obtained.

In the case of molding the outer casing 8 by the drawing and ironing, by changing a part of the die which is used, an external size such as width, depth, height, or the like of the outer casing 8 can be easily changed. Therefore, a degree of freedom when the outer casing 8 is formed is high and the outer casing 8 according to the battery cell 1 of various sizes can be easily formed.

Since the outer casing 8 is made of the metal material, an inner surface process and a sheathing process can be easily executed. Thus, for example, the processes for the insulation, surface protection, and the like can be easily performed to the inner surface and/or outer surface of the outer casing 8 and the safety of the battery pack can be easily improved.

Since the outer casing 8 is also the metal casing, there is an effect of preventing the penetration of the moisture into the battery. Therefore, as for a battery cell which is inserted into the casing, the battery cell in which the battery element has been sealed into a resin film instead of the aluminum laminate film can be also used. The resin film is a complex film in which an outside resin layer that is adhered onto an outer surface of an aluminum layer of the aluminum laminate film and an inside resin layer that is adhered onto an inner surface of the aluminum layer are directly adhered. In the case of using such a complex film, since the aluminum layer (metal layer) is unnecessary, the volume efficiency can be further improved.

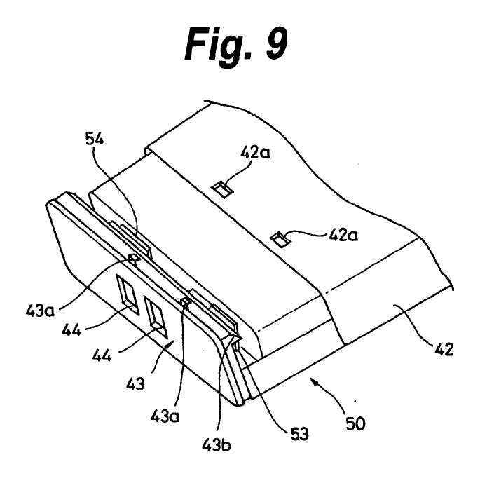

As for the front cap, as shown in FIG. 9, fitting projecting portions 43a are provided for a cap 43 side and fitting hole portions 42a are provided for an outer casing 42 side. When the cap 43 is inserted into the outer casing 42 with a pressure, the fitting projecting portions 43a are inserted into the fitting hole portions 42a, so that the cap 43 can be certainly fixed to the outer casing 42. In such a case, a tapered surface 43b can be also formed at one side edge of the cap 43 so as to make the insertion into the outer casing 42 easy. By closing the outer casing 42 by the cap 43 as mentioned above, the battery pack can certainly seal hermetically the inside of the outer casing 42 and prevent the penetration of the moisture, dust, and the like, and the high reliability can be obtained.

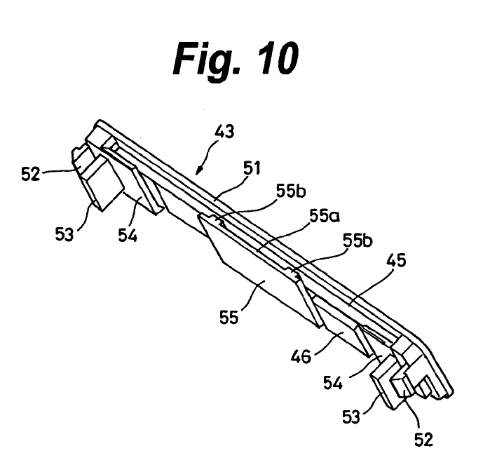

In the foregoing battery pack 1, various modifications are possible. For example, as an assembly structure of the cap 43 and a circuit board 45, an assembly structure of shown in FIG. 10 can be also used. The assembly structure of the cap 43 and the circuit board 45 will be described hereinbelow.

First, the cap 43 in this case is mainly constructed by a cap plate 51 for closing an opening portion of the outer casing 42 in a manner similar to the foregoing example. Retaining claws 52 adapted to be retained to the outer casing 42 are provided for both end portions of the cap 43 so as to be outwardly projected. A battery main body supporting projection 53 which is come into contact with a battery 50 when the cap 43 is attached to the outer casing 42 and fixes the battery is formed at the inside position of each of the retaining claws 52. Further, board both-ends supporting portions 54 and a board center supporting portion 55 are provided at a predetermined interval from the cap plate 51, that is, at an interval which is almost equal to a thickness of circuit board 45. The circuit board 45 is inserted into a gap between the cap plate 51 and the board both-ends supporting portions 54 and a gap between the cap plate 51 and the board center supporting portion 55 and held to the cap 43.

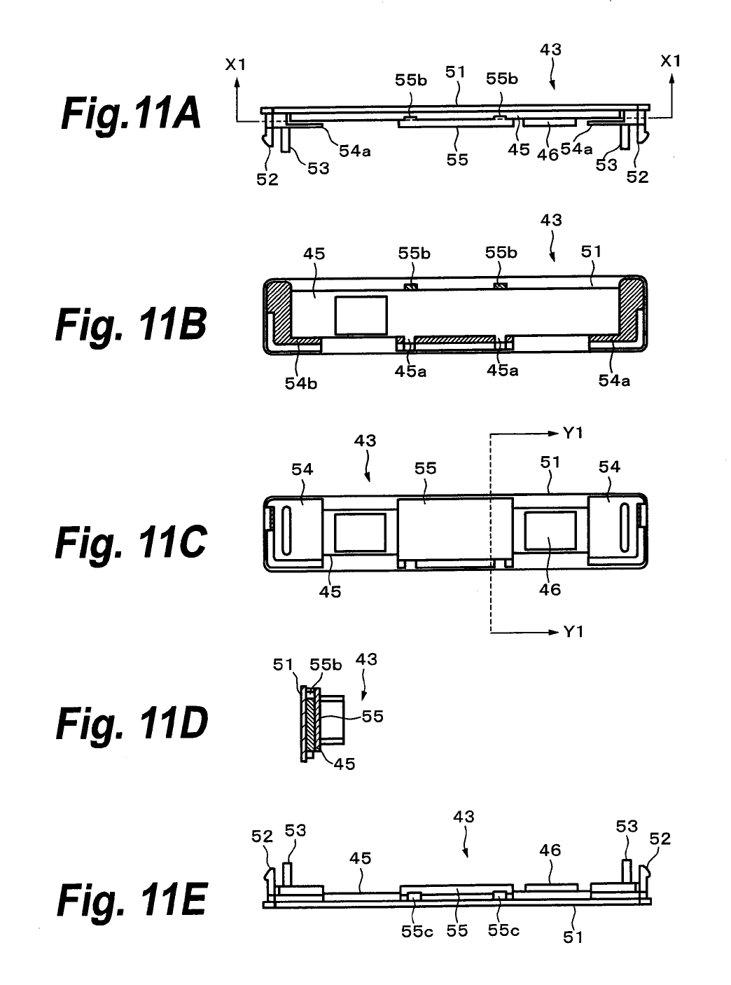

FIG. 11 shows a detailed construction of the cap 43. Each of the board both-ends supporting portions 54 has not only a supporting plate 54a for supporting a rear surface of the circuit board 45 but also a side edge supporting portion 54b for supporting one side edge of the circuit board 45. Therefore, when the circuit board 45 is inserted into the gaps, the circuit board 45 is positioned in the inserting direction by the side edge supporting portion 54b.

One side edge side of the board center supporting portion 55 is coupled with the cap plate 51 and the other side edge 55a side is a free edge. The board center supporting portion 55 is urged to the cap plate 51 side by, for example, an elastic force which the resin has. By inserting the circuit board 45 against the urging force, the circuit board 45 is attached to the cap 43 in the state where the rear surface is urged by the board center supporting portion 55. A pair of retaining claws 55b are provided for the other side edge 55a side of the board center supporting portion 55. When the circuit board 45 is attached, the retaining claws 55b support the side surface of the circuit board 45 and position the circuit board 45 in the vertical direction in the diagram together with the far side edge supporting portion 54b, thereby preventing an unexpected drop-out of the circuit board 45.

Further, positioning holes 55c are provided for a base edge side of the board center supporting portion 55. Positioning projections 45a are provided for the circuit board 45 at the positions corresponding to the positioning holes 55c. When the circuit board 45 is attached into the gaps, by inserting the positioning projections 45a of the circuit board 45 into the positioning holes 55c of the board center supporting portion 55, the positioning of the circuit board 45 into the cap 43, particularly, the positioning in the right/left direction in the diagram is made.

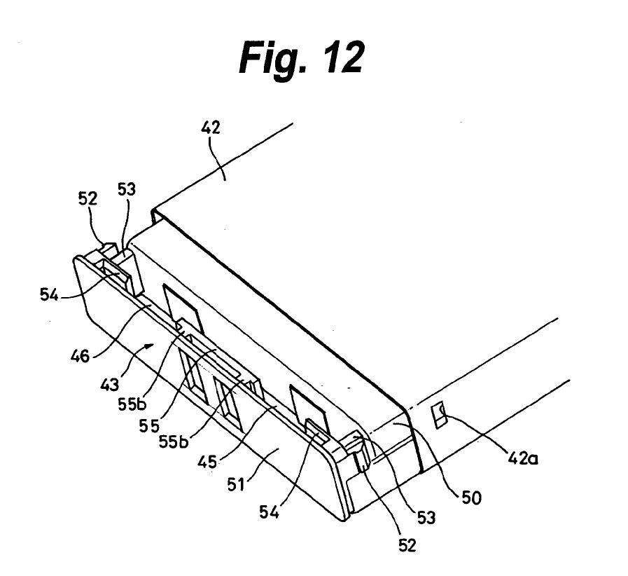

FIG. 12 shows an attaching state of the cap 43 into the outer casing 42. By pressing the cap 43 together with the battery 50 and retaining the retaining claws 52 of the cap 43 into the fitting hole portions 42a of the outer casing 42, the closure of the outer casing 42 by the cap 43 can be performed. At this time, the battery main body supporting projection 53 provided for the cap 43 is come into contact with an edge surface of the battery 50, so that the battery 50 is certainly fixed in the outer casing 42.

A battery pack using a battery element which is not externally covered with the laminate film will now be described as another embodiment. Such a battery pack will be explained hereinbelow with reference to the drawings.

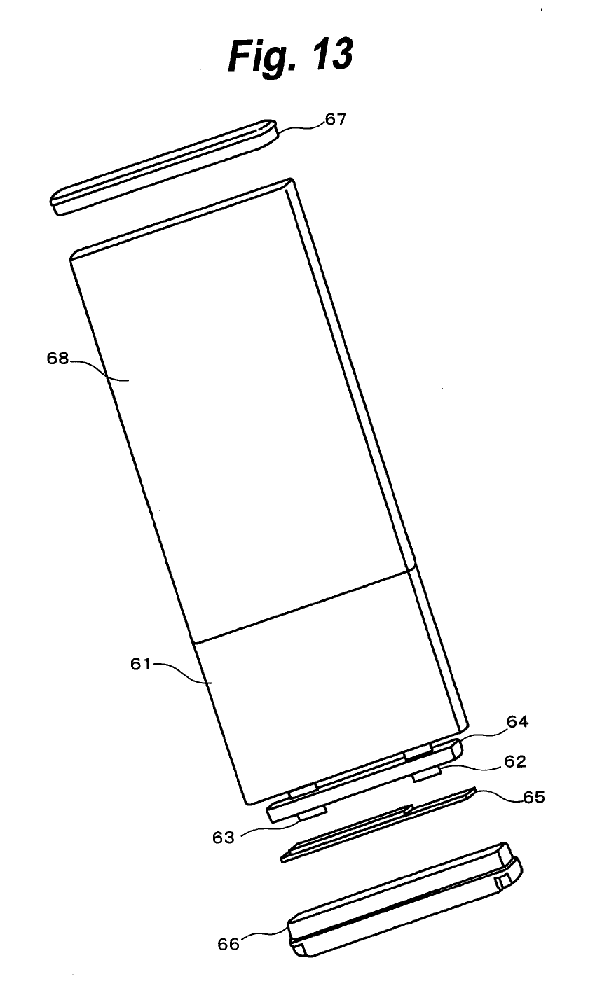

FIG. 13 is an exploded perspective view of a battery pack using a battery cell which is not externally covered with the laminate film. Reference numeral 61 denotes a battery element of a battery such as a lithium ion polymer secondary battery. The battery element 61 can be formed by materials and a method which are similar to those in the foregoing embodiment.

In a manner similar to the foregoing embodiment, leads 62 and 63 to which a holding member 64 has been attached are led out of one end surface of a front side of the battery element 61. The holding member 64 is made of, for example, a synthetic resin material having insulation performance, stably holds a circuit board 65, and insulates the circuit board 65 from the battery element 61. The circuit board 65 is fixed to the leads 62 and 63 projected from the holding member 64 by the resistance welding, ultrasonic welding, or the like. A protecting circuit, an ID resistance, and the like are mounted on the circuit board 65. The circuit board 65 fixed to the leads 62 and 63 is enclosed in a front cap 66. A plurality of, for example, three contact portions are formed on the circuit board 65 of the front cap 66 side.

The front cap 66 and a rear cap 67 are molded members which are molded from, for example, a synthetic resin material such as polycarbonate (PC), polypropylene (PP), ABS resin (acrylonitrile butadiene styrene), hot melt resin of a polyamide system, or the like. The front cap 66 and the rear cap 67 are attached to opening portions at both ends of a cylindrical outer casing 68 and close the outer casing 68. In the case of using the battery element without externally sheathing it with the laminate film, since insulation performance is required for the front cap 66 and the rear cap 67, a material such as aluminum, stainless steel (SUS), or the like is not used.

A moisture trapper may be mixed to the resin constructing the front cap 66 and the rear cap 67 in order to improve moisture barrier performance. As a moisture trapper, a trapper such as sulfate whose general expression is shown by MSO₄ or M₂SO₄ (in the expression, M is selected from Na, K, Mg, and Ca), polyacrylate whose general expression is shown by (—CH₂—CH(COOM)—)ₙ (in the expression, M is selected from Na, K, Mg, and Ca), or the like which can easily form a hydrate is preferably used and mixed into the resin at a rate which lies within a range from 0.2% or more to 10% or less.

The pair of caps comprising the front cap 66 and the rear cap 67 are joined to the outer casing 68 by an attaching method suitable for their material. If the caps are made of the synthetic resin material, for example, by laminating a thin film of polypropylene (PP), polyethylene (PE), or the like onto joint surfaces of the outer casing 68 and the caps and heating the joint surfaces, the caps and the outer casing 68 can be fixed by the thermal welding.

If the hot melt system resin is used, the outer casing 68 and the caps can be adhered simultaneously with the molding of the outer shapes of the caps. The moisture trapper may be mixed to the hot melt system resin in order to improve the moisture barrier performance. As a moisture trapper, a trapper such as sulfate whose general expression is shown by MSO₄ or M₂SO₄ (in the expression, M is selected from Na, K, Mg, and Ca), polyacrylate whose general expression is shown by (—CH₂—CH(COOM)—)ₙ (in the expression, M is selected from Na, K, Mg, and Ca), or the like which can easily form a hydrate is preferably used and mixed into the resin at a rate which lies within a range from 0.2% or more to 10% or less.

In a manner similar to the case of the foregoing embodiment, the outer casing 68 has a cylindrical shape adapted to insert and enclose the battery element 61 therein. As for a thickness of outer casing 68, it is formed by the DI molding method so as to have a thickness of about 0.1 mm. The outer casing 68 is made of the metal such as aluminum, iron, stainless steel (SUS), or the like. The material such as 3003H18, 3004H18, 1N30H18, or the like can be used as aluminum. According to those aluminum materials, since the Vickers hardness is equal to or larger than 20, even if the thickness of outer casing is very small to be equal to about 0.1 mm, the strength can be assured.

The battery pack is manufactured by the component elements as mentioned above. As parts which are used when manufacturing the battery pack and their materials, the parts and materials similar to those used in the foregoing embodiment can be used.

Since the battery element is used without externally being covered with the laminate film, it is important to execute the insulating process to the inner surface of the outer casing 68. As a method of the insulating process, specifically speaking, in the case where the outer casing 68 is made of aluminum, a method of alumite-processing its inner wall portion can be mentioned. The alumite process is executed to form an anodic oxide coating onto the surface of aluminum and the oxide coating plays a role of an insulating layer. According to the alumite process, the surface can be insulated without increasing the thickness of outer casing 68. The portion which is subjected to the alumite process is at least the inner wall of the outer casing 68 having a possibility that it is come into contact with the battery element 61. However, the invention is not limited to such a portion but the alumite process may be executed to the whole outer casing.

Or, in place of the alumite process, the outer casing 68 is formed by deeply drawing a complex material obtained by adhering a resin film to aluminum and the resin film is arranged to the inner wall side, thereby also enabling the insulation performance to the battery element 61 to be assured. In such a case, most of the outer casing 68 is made of aluminum and there is obtained the state where a resin film of polypropylene, polyethylene, ionomer, ethylene-methacrylate copolymer, ethylene-methacrylic acid copolymer, ethylene-methylacrylate copolymer, or the like has been adhered onto the inner wall surface.

It is preferable to set a thickness of resin film to 5 to 30 mm. Since the outer casing 68 obtained by molding the cylindrical shape into the rectangular shape is used, there is a case where even after it was molded into the rectangular shape and the battery element 61 was enclosed, the outer casing is intended to return to the original shape and is deformed into an expanded shape. By adhering the resin film, since thermal adhesive property can be obtained to the battery element enclosed in the outer casing, a change in the completed pack can be suppressed.

The insulation can be also accomplished by such a structure that a separator which is arranged between the positive electrode and the negative electrode is set to be longer than each of the positive electrode and the negative electrode upon manufacturing of the battery element 61 and the outer peripheral portion of the battery element 61 is covered with the separator or a method of spray-coating a paint to the inner wall portion and, thereafter, executing a baking process.

As described above, in the battery pack according to the embodiment, since the battery element which is enclosed in the casing is used without being externally covered with the laminate film, the sufficient mechanical strength and reliability and safety of the terminals can be assured and the volume efficiency can be further improved. While the volume efficiency to the battery main body according to the conventional battery pack using the molded casing is equal to about 78%, the volume efficiency of 95% or more can be obtained in the case of the battery pack of the embodiment.

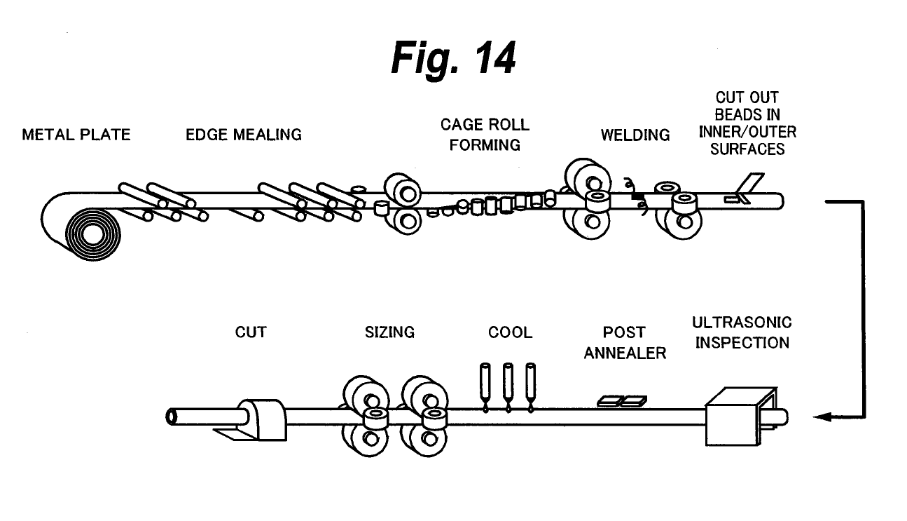

Although the cylindrical casing member (metal pipe) has been formed by the DI molding method in the foregoing embodiment, the creation of the cylindrical casing member is not limited to such a method but it can be also formed by a roll forming method as shown in FIG. 14 or the like. In the case of forming the cylindrical casing member by the roll forming method, a plurality of rolling rollers for molding are arranged on the outer periphery side of the circular can and the circular can is gradually pierced among the plurality of rollers, thereby molding the casing member into a necessary shape.

The invention will be described hereinbelow with respect to Embodiments. In Embodiments, battery packs are formed while changing constructions of the battery element (the presence or absence of the laminate film sheathing) and the outer casing, and the volume efficiencies are compared.

### EMBODIMENT 1

An assembly in which the circuit board and the like have been connected to a battery cell in which a battery element having a thickness of 4.0 mm has externally been covered with an aluminum laminate having a thickness of 0.1 mm is inserted into a cylindrical collapsed can obtained by molding a cylindrical metal pipe having a thickness of 0.1 mm manufactured by the DI molding method into the rectangular shape, and a front cap and a rear cap formed by the resin molding are fitted to both opening end portions of the cylindrical collapsed can and welded to the outer casing, thereby forming a battery pack.

### EMBODIMENT 2

An assembly in which the circuit board and the like have been connected to a battery cell in which a battery element having a thickness of 4.0 mm has externally been covered with an aluminum laminate having a thickness of 0.1 mm is inserted into a cylindrical collapsed can obtained by molding a cylindrical metal pipe having a thickness of 0.1 mm manufactured by the roll forming method into the rectangular shape, and the front cap and the rear cap formed by the resin molding are fitted to both opening end portions of the cylindrical collapsed can and welded to the outer casing, thereby forming a battery pack.

### EMBODIMENT 3

An assembly in which a battery element having a thickness of 4.0 mm to which the circuit board and the like have been connected is externally covered with a complex film having a thickness of 0.05 mm is inserted into a cylindrical collapsed can obtained by molding a cylindrical metal pipe having a thickness of 0.1 mm manufactured by the DI molding method into the rectangular shape, and the front cap and the rear cap formed by the resin molding are fitted to both opening end portions of the cylindrical collapsed can and welded to the outer casing, thereby forming a battery pack.

### EMBODIMENT 4

An assembly in which a battery element having a thickness of 4.0 mm to which the circuit board and the like have been connected is externally covered with a complex film having a thickness of 0.05 mm is inserted into a cylindrical collapsed can obtained by molding a cylindrical metal pipe having a thickness of 0.1 mm manufactured by the roll forming method into the rectangular shape, and the front cap and the rear cap formed by the resin molding are fitted to both opening end portions of the cylindrical collapsed can and welded to the outer casing, thereby forming a battery pack.

<Comparison 1>

An assembly in which the circuit board and the like have been connected to a battery cell in which a battery element having a thickness of 4.0 mm has externally been covered with an aluminum laminate film having a thickness of 0.1 mm is inserted into a molded casing manufactured by the resin molding, thereby forming a battery pack.

<Comparison 2>

An assembly in which the circuit board and the like have been connected to a battery cell in which a battery element having a thickness of 4.0 mm has externally been covered with an aluminum laminate film having a thickness of 0.1 mm is inserted into a rectangular can having a thickness of 0.2 mm manufactured by the deep drawing and battery caps are welded, thereby forming a battery pack.

With respect to each of the battery packs manufactured as mentioned above, a volume of the battery pack and a volume of the battery element enclosed in the battery are measured, thereby obtaining the volume efficiency from (the volume of the battery element)/(the volume of the battery pack).

A result of the measurement is shown in the following Table 1.

| | Battery element | | | | | |
|---|---|---|---|---|---|---|
| | | Thickness | | | | |
| | | of | Outer casing | | | Volume |
| | | sheathing | Kind of | Thickness | Forming | efficiency |
| | Sheathing | [mm] | sheathing | [mm] | method | [%] |
| Embodiment 1 | Al | 0.1 | Cylindrical | 0.1 | DI | 92 |
| | laminate | | collapsed | | molding | |
| | | | can | | | |
| Embodiment 2 | Al | 0.1 | Cylindrical | 0.1 | Roll | 92 |
| | laminate | | collapsed | | forming | |
| | | | can | | | |
| Embodiment 3 | Complex | 0.05 | Cylindrical | 0.1 | DI | 95 |
| | film | | collapsed | | molding | |
| | | | can | | | |
| Embodiment 4 | Complex | 0.05 | Cylindrical | 0.1 | Roll | 95 |
| | film | | collapsed | | forming | |
| | | | can | | | |
| Comparison 1 | Al | 0.1 | Resin mold | | | 78 |
| | laminate | | | | | |
| Comparison 2 | Al | 0.1 | Rectangular | 0.2 | Drawing | 86 |
| | laminate | | can | | can | |

From the above result, according to the battery pack with such a conventional construction that the battery cell which was externally covered with the laminate film has been inserted into the resin molded casing, although the volume efficiency is equal to 78%, according to the battery packs of the present invention in which the battery cell has been inserted into the outer casing obtained by molding the metal pipe manufactured by the DI molding method or the roll forming method into the rectangular shape, the volume efficiency is equal to or larger than 92%, and it will be understood that the volume efficiency is extremely improved.

Among them, according to the battery pack using the battery cell in which the battery element is not externally covered with the laminate film, the volume efficiency is equal to 95% and the battery element can be manufactured without a waste of structure. Consequently, if the external dimensions of the outer casing are set to be constant, the dimensions of the battery main body which is enclosed in the outer casing can be enlarged and the battery capacity can be increased. On the contrary, if the battery capacity is set to be constant, the battery pack can be miniaturized.

The invention is not limited to the foregoing two embodiments and the like but many modifications and applications are possible within the scope of the invention without departing from the spirit of the invention. Although the above embodiments have been described with respect to the lithium ion polymer secondary battery using the gel electrolyte, the kind of battery is not limited to such a type. The invention can be also applied to other kinds of batteries to which the cylindrical outer casing can be used, for example, battery elements using a solid electrolyte or a liquid electrolyte.

The attaching structure of the circuit board 5, the front cap 6, and the like is not limited to the structure using the holding member 4 shown in FIG. 1. For example, it is also possible to use a structure in which the leads 2 and 3 are sandwiched by the circuit board 5 and the front cap 6, the leads 2 and 3 between the sandwiched portions and the battery element 1 are bent, and the outer casing 8 is inserted with a pressure so as to press the front cap 6, thereby joining the outer casing 8 and the front cap 6. Naturally, such a method can be also used in the case where the battery element as shown in FIG. 12 is not externally covered with the laminate film as shown in FIG. 12.

1. A battery pack comprising:
a battery cell in which a battery element is enclosed in a film-shaped sheathing member having insulation performance;
a rectangular outer casing constructed in such a manner that, after a metal material was formed into a cylindrical shape, said cylindrical shape is molded into a pipe shape which almost coincides with an outer shape of said battery element and opening portions are formed at both ends; and
a pair of caps which are respectively fitted to the opening portions of said outer casing,
wherein said battery cell is enclosed in said outer casing and said opening portions are closed by said pair of caps.

2. A battery pack according to claim 1, wherein the metal material of said outer casing is selected from a group consisting of iron, titanium, stainless steel, and aluminum.

3. A battery pack according to claim 2, wherein a Vickers hardness of said metal material is equal to or larger than 20.

4. A battery pack according to claim 2, wherein said aluminum is selected from a group consisting of 3003H18, 3004H18, and 1N30H18.

5. A battery pack according to claim 1, wherein said film-shaped sheathing member is formed by laminating a resin film.

6. A battery pack according to claim 5, wherein
said film-shaped sheathing member is formed by adhering an outer layer resin film whose thickness lies within a range from 10 μm or more to 25 μm or less and an inner layer resin film whose thickness lies within a range from 25 μm or more to 35 μm or less by an adhesive agent, and
a moisture trapper for absorbing the moisture is mixed to said adhesive agent.

7. A battery pack according to claim 6, wherein said outer layer resin film is selected from a group consisting of polyethylene terephthalate, nylon, polyethylene naphthalate, polybutylene terephthalate.

8. A battery pack according to claim 6, wherein said inner layer resin film is selected from a group consisting of polypropylene, maleate-denatured polypropylene, polyethylene, maleate-denatured polyethylene, ionomer, ethylene-methacrylate copolymer, ethylene-methacrylic acid copolymer, and ethylene-methylacrylate copolymer.

9. A battery pack according to claim 6, wherein
said moisture trapper is selected from a group consisting of sulfate whose general expression is shown by MSO₄ or M₂SO₄ (in the expression, M is selected from Na, K, Mg, and Ca) or polyacrylate whose general expression is shown by (—CH₂—CH(COOM)_)ₙ (in the expression, M is selected from Na, K, Mg, and Ca),
and said moisture trapper is mixed at a rate within a range from 1% or more to 10% or less.

10. A battery pack according to claim 6, wherein an evaporation deposition film of metal or a metal oxide is formed on at least either an outer surface of said outer layer resin film or an inner surface of said inner layer resin film.

11. A battery pack according to claim 1, wherein said outer casing is formed by a DI molding method.

12. A battery pack according to claim 1, wherein said outer casing is formed by a roll forming method.

13. A battery pack according to claim 1, wherein a circuit board is arranged on the inside of at least one of said pair of caps.

14. A battery pack according to claim 1, wherein said battery element has a gel or solid electrolyte.

15. A battery pack according to claim 1, wherein a thermally welding resin film is formed on an inner surface of said outer casing.

16. A battery pack according to claim 15, wherein said thermally welding resin film is selected from a group consisting of polypropylene, maleate-denatured polypropylene, polyethylene, maleate-denatured polyethylene, ionomer, ethylene-methacrylate copolymer, ethylene-methacrylic acid copolymer, and ethylene-methylacrylate copolymer.

17. A battery pack according to claim 1, wherein at least an outer surface of said outer casing is subjected to an insulating process.

18. A battery pack according to claim 17, wherein said insulating process also serves as a design print.

19. A battery pack according to claim 17, wherein said design print is printed by a laser.

20. A battery pack comprising:
a battery element;
a rectangular outer casing constructed in such a manner that, after a metal material was formed into a cylindrical shape, said cylindrical shape is molded into a pipe shape which almost coincides with an outer shape of said battery element and opening portions are formed at both ends; and
a pair of caps which are respectively fitted to the opening portions of said outer casing,
wherein said battery element is enclosed in said outer casing and said opening portions are closed by said pair of caps.

21. A battery pack according to claim 20, wherein the metal material of said outer casing is selected from a group consisting of iron, titanium, stainless steel, and aluminum.

22. A battery pack according to claim 21, wherein a Vickers hardness of said metal material is equal to or larger than 20.

23. A battery pack according to claim 21, wherein said aluminum is selected from a group consisting of 3003H18, 3004H18, and 1N30H18.

24. A battery pack according to claim 20, wherein said outer casing is formed by a DI molding method.

25. A battery pack according to claim 20, wherein said outer casing is formed by a roll forming method.

26. A battery pack according to claim 20, wherein a circuit board is arranged on the inside of at least one of said pair of caps.

27. A battery pack according to claim 20, wherein said caps are formed by a resin molding.

28. A battery pack according to claim 20, wherein a moisture trapper for absorbing the moisture is mixed to a resin material of said caps.

29. A battery pack according to claim 28, wherein
said moisture trapper is selected from a group consisting of sulfate whose general expression is shown by MSO₄ or M₂SO₄ (in the expression, M is selected from Na, K, Mg, and Ca) or polyacrylate whose general expression is shown by (—CH₂—CH(COOM)_)ₙ (in the expression, M is selected from Na, K, Mg, and Ca),
and said moisture trapper is mixed at a rate within a range from 0.2% or more to 10% or less.

30. A battery pack according to claim 20, wherein said battery element has a gel or solid electrolyte.

31. A battery pack according to claim 20, wherein at least an inner surface of said outer casing is subjected to an insulating process.

32. A battery pack according to claim 31, wherein
said insulating process is executed by forming a resin film onto the inner surface of said outer casing, and
said resin film is selected from a group consisting of polypropylene, maleate-denatured polypropylene, polyethylene, maleate-denatured polyethylene, ionomer, ethylene-methacrylate copolymer, ethylene-methacrylic acid copolymer, and ethylene-methylacrylate copolymer.

33. A battery pack according to claim 20, wherein at least an outer surface of said outer casing is subjected to an insulating process.

34. A battery pack according to claim 33, wherein said insulating process also serves as a design print.

35. A battery pack according to claim 33, wherein lot information or the like has been printed to said design print by a laser.

36. A manufacturing method of a battery pack, comprising the steps of:
forming a power generating element;
connecting a circuit board to said power generating element;
forming a casing member by molding a metal material into a cylindrical shape;
forming an outer casing by molding said casing member into a pipe shape which almost coincides with an outer shape of said power generating element; and
enclosing said power generating element into said outer casing and closing opening end portions of said outer casing by a pair of caps.

37. A manufacturing method of the battery pack according to claim 36, wherein said power generating element is a battery cell in which a battery element has been enclosed in a film-shaped sheathing member having insulation performance.

38. A manufacturing method of the battery pack according to claim 35, wherein said power generating element is a battery element which is not enclosed in a film-shaped sheathing member.
